(19) United States
(12) Patent Application Publication
(10) Pub. No.: US 2019/0345967 A1
(43) Pub. Date: Nov. 14, 2019

(54) Farm Implements Used with A Quick Hitch Adapter

(71) Applicant: CLAAS Saulgau GmbH, 88348 Bad Saulgau (DE)

(72) Inventors: Martin Ober, Trichtingen (DE); Bernd Schneider, Hornstein/Bingen (DE)

(21) Appl. No.: 16/520,519

(22) Filed: Jul. 24, 2019

Related U.S. Application Data
(63) Continuation of application No. 15/419,234, filed on Jan. 30, 2017, now abandoned.

(51) Int. Cl. F16B 19/02; A01B 59/00

(52) U.S. Cl. CPC F16B 19/02; F16B 41/002; A01B 59/002

(57) ABSTRACT

A more robust attachment member or pin is provided for use with farm implements that are attached to a farm vehicle by a quick hitch adapter. The attachment member includes an elongated member having a length and extending between a first end and a second end; and at least three surfaces extending longitudinally along a substantial portion of the elongated member between the first and second ends, the at least three surfaces having at least two different radii. Two of the surfaces are either generally flat or have a very large radius. Two other surfaces, disposed between the generally flat surfaces, have a smaller radius and the two other surfaces may have the same or different radii.

This application claims priority under 35 U.S.C. § 120 to U.S. patent application Ser. No. 15/419,234, filed Jan. 30, 2017, the contents of which are incorporated herein by reference.

### BACKGROUND OF THE INVENTION

### Field of the Invention

Many farm implements are attached to a farm vehicle, such as a tractor, with a quick hitch type adapter. The quick hitch adapter, which is connected to the farm vehicle's power take-off, typically has three hooks (one upper and two lower) that each engage attachment members or pins on the farm implements. Some of the farm implements are quite heavy (belt mowers) or extend rearwardly from the farm vehicle exerting a high amount of stress on the attachment members or pins. The bending or complete failure of the pins is a dangerous condition and causes the user of the vehicle and farm implement to have change out the pins.

Thus, a more robust attachment member or pin is needed to be able to handle the high loads.

### SUMMARY OF THE INVENTION

The present invention is directed to an attachment member for a quick hitch adapting unit that includes an elongated member having a length and extending between a first end and a second end, and at least three surfaces extending longitudinally along a substantial portion of the elongated member between the first and second ends, the at least three surfaces having at least two different radii.

In some embodiments, the at least three surfaces include a first surface extending longitudinally along at least a substantial portion of the elongated member between the first and second ends and having a first radius, a second surface extending longitudinally along a substantial portion of the elongated member between the first and second ends, the second surface having a second radius and being parallel to the first surface, and a third surface extending longitudinally along a substantial portion of the length of the elongated member between the first and second ends, the third surface disposed between the first and second surfaces and having a third radius.

In some other embodiments, the first radius and the second radius are infinite thereby making the first surface and the second surface generally flat.

In another embodiment, the first radius and the second radius are less than infinite and greater than the third radius.

According to another aspect of the present invention, there is a support on a farm implement, the support to be engaged by a quick hitch adapting unit on an agricultural machine that includes two flanges space apart from another, at least one opening in each of the two flanges, and an attachment member disposed within the at least one opening, the attachment member includes a first surface extending along at least a substantial portion of the elongated member between the first and second ends and having a first radius, a second surface extending along a substantial portion of the elongated member between the first and second ends, the second surface having a second radius and being parallel to one the first surface, and a third surface extending along a substantial portion of the length of the elongated member between the first and second ends, the third surface disposed between the first and second surfaces and having a third radius.

In yet another aspect of the present invention, there is an attachment member for a quick hitch adapting unit that includes an elongated member having a length and extending between a first end and a second end, a first generally flat surface extending longitudinally along at least a portion of the elongated member between the first and second ends, a second generally flat surface extending longitudinally along at least a portion of the elongated member between the first and second ends, the first generally flat surface and the second generally flat surface being parallel to one another, and a first radiused portion extending longitudinally along at least a portion of the length of the elongated member between the first and second ends, the first radiused portion disposed between the first and second generally flat surfaces.

It is to be understood that both the foregoing general description and the following detailed description of the present embodiments of the invention are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and, together with the description, serve to explain the principles and operation of the invention.

### BRIEF DESCRIPTION OF THE DRAWINGS

FIG. 1 is a perspective view of one embodiment of an attachment member or pin according to the present invention;

FIG. 2 is a perspective view of second embodiment of an attachment member according to the present invention;

FIG. 3 is a perspective view third embodiment of an attachment member according to the present invention;

FIG. 4 is an end view of the attachment member of FIG. 1;

FIG. 5 is an end view of an alternative embodiment of an attachment member according to the present invention;

FIG. 6 is an end view of an alternative embodiment of an attachment member according to the present invention;

FIG. 7 is an end view of an another alternative embodiment of an attachment member according to the present invention;

FIG. 8 is a perspective view of a quick hitch adapter and a portion of a support for a farm implement using the attachment member of FIG. 1;

FIG. 9 is a perspective view of a portion of a quick hitch adapter and a portion of a support using the attachment member of FIG. 1 with a different opening in the support;

FIG. 10 is a perspective view of a portion of a quick hitch adapter and a portion of a support using the attachment member of FIG. 2;

FIG. 11 is an enlarged view of the attachment member and support of FIG. 10; and

FIG. 12 is a perspective view of a portion of a quick hitch adapter and a portion of a support using the attachment member of FIG. 2 in an opening in the support in an inverted position.

### DETAILED DESCRIPTION OF THE PREFERRED EMBODIMENTS

Reference will now be made in detail to the present preferred embodiment(s) of the invention, examples of which are illustrated in the accompanying drawings. Whenever possible, the same reference numerals will be used throughout the drawings to refer to the same or like parts.

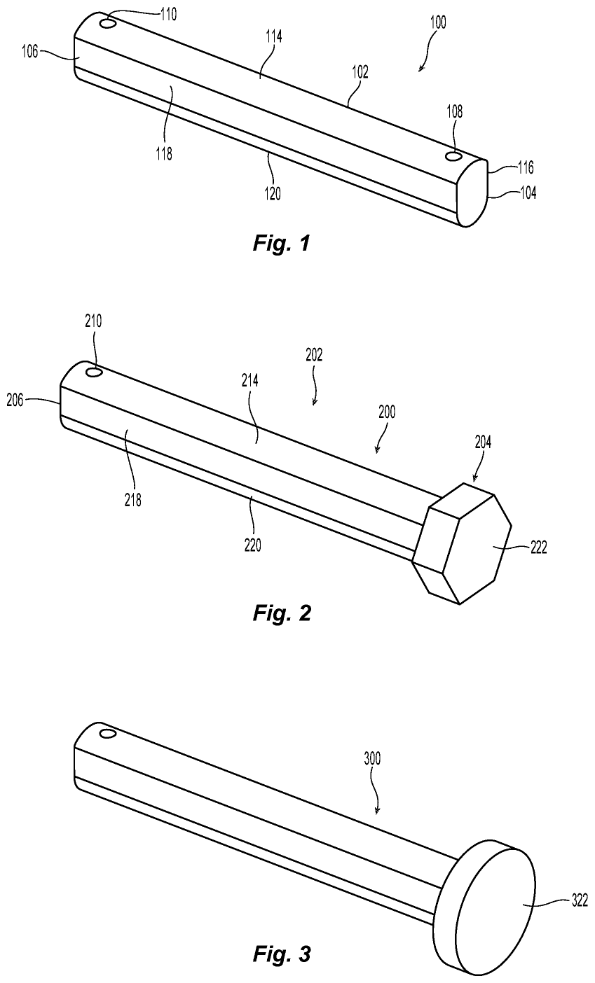

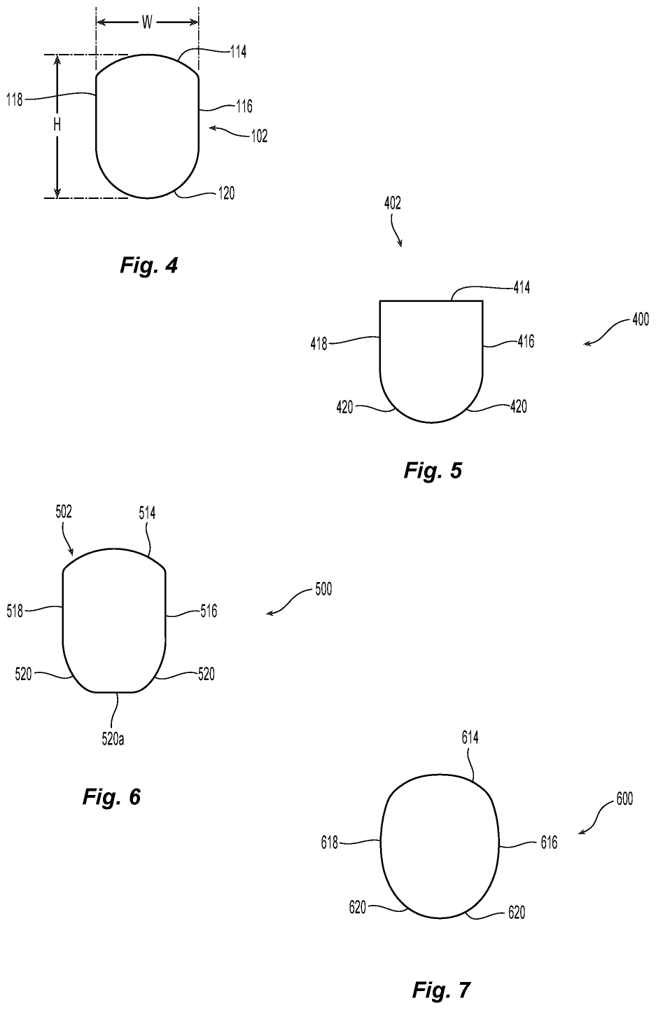

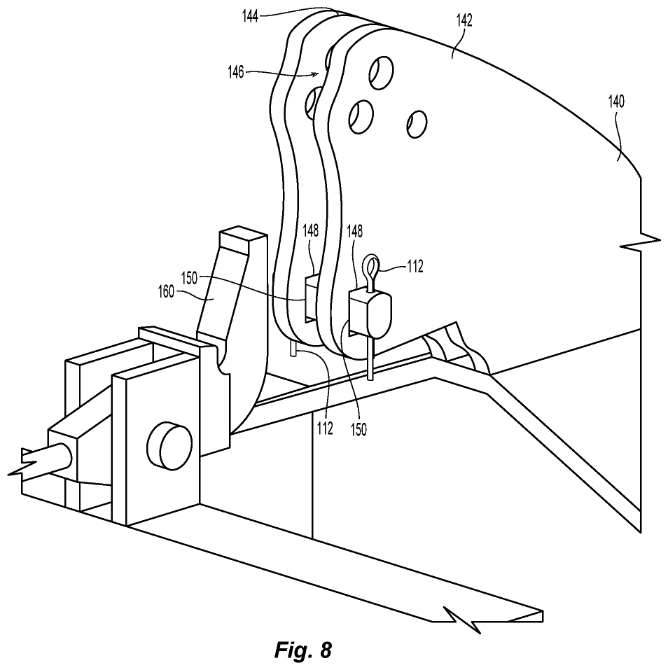

Further to the above discussion, one embodiment of an attachment member or pin 100 according to the present invention is illustrated in FIGS. 1 and 4. The attachment member 100 includes an elongated member 102 having a length and extending between a first end 104 and a second end 106. The elongated member 102 may also have a first opening 108 adjacent the first end 104 and a second opening 110 adjacent the second end 106 to accept a securing member (e.g., a cotter pin, hairpin, or the like) 112 as illustrated in FIG. 8. The elongated member 102 preferably has four surfaces or sides 114,116, 118, and 120, as best seen in FIG. 4. The elongated member 102 also has a height H and a width W. Preferably, the height H is at least as large as the width W of the elongated member 102. However, the height may be the same as or even smaller than the width and still fall within the present invention. The four surfaces are preferably smooth—and do not have a projection or helical threads extending along the length.

The surface 114, illustrated to be a top surface of elongated member 102 is preferably curved and the curved surface has a radius of 22.5 mm, but could be of any appropriate curvature. The radius of 22.5 mm matches the size of the hook opening of a category III quick hitch adapter. The curved surface 114 preferably extends between the first end 104 and the second end 106, but may also only extend along a portion of the longitudinal length of the elongated member 102 (the surfaces also do not extend helically around the elongated member 102 but directly between the first end 104 and the second end 106) and not extend along the entire length thereof.

The elongated member 102 also has two side surfaces 116,118. As best seen in FIG. 4, the two side surfaces 116,118 are parallel to one another and are generally flat. As such, these side surfaces could also be considered as having a radius—an infinite radius, Thereby making the surfaces generally flat. The two side surfaces 116,118 are preferably the surfaces that engage the hook on the quick hitch adapter and against which the force from the movement of the farm vehicle and support portion of the farm implements is applied. In this way, the hook from the the quick hitch adapter has a larger engagement area with the attachment member 100 than with a typical cylindrical pin or bushing. Similar to surface 114, the two side surfaces 116,118 extend along a portion of the longitudinal length of the elongated member 102 and preferably along the entire length thereof. It is noted that the the two side surfaces 116,118 are separated from one another by the surface 114 on one side of the elongated member 102 and also by a fourth surface 120 on an opposite side of the elongated member 102.

The fourth surface 120 is also preferably curved and the curved surface has a radius of 16 mm, but could be of any appropriate curvature. The radius of 16 mm matches the size of a hook opening of a category II quick hitch adapter. The fourth surface 120 preferably extends between the first end 104 and the second end 106, but may also only extend along a portion of the longitudinal length of the elongated member 102 (and not extend along the entire length thereof.

As noted above, the elongated member 102 has a first opening 108 and a second opening 110 to receive securing member 112 to retain the elongated member 102 in the support on the farm implement. While the openings are illustrated as extended between the surface 114 and the fourth surface 120, the openings 108, 110 could also extend between the sides 116,118. As illustrated in FIG. 8, there is a portion of a support member 140 showing two flanges 142,144 with an space 146 therebetween. In each of the flanges 142,144 is an opening 148 to receive the attachment member 100. The illustrated portion of the support member 140, as recognized by one of skill in the art, is the upper portion of the support 140. The openings 148 and the attachment members 100 could also be used with the lower portion of the support 140, if so desired. The attachment member 100 is inserted (from either side of the support member 140) into the openings 148 and through the space 146. One of the securing members 112 is first inserted into one of the first opening 108 and second opening 110 to prevent the user from pushing the attachment member 100 through the support 140. Once inserted in the flanges 142,144, a second securing member 112 can be inserted into the other of the openings to retain the attachment member 100 within the support 140.

The openings 148 are illustrated in FIGS. 8, 10, and 11 as being rectangular. The openings 148 should be sized to maintain the attachment member 100 in the orientation in which it is inserted into the support 140. Thus, there may be a little play up and down (corresponding to the height H in FIG. 4) and side to side (width W) for the attachment member 100. The attachment member 100, during use of the support 140, will engage the front side 150 of the opening 148 in the support 140 along one of the side surfaces 116,118. Given the generally flat configuration of the side surfaces 116,118, there will be more of the attachment member engaging the support 140 as well as the hook 160 on the quick hitch adapter. Such a configuration of the attachment member 100 increases the cross-sectional area providing more resistance to bending or breaking while still allowing for use with the standard sizes of hooks 160.

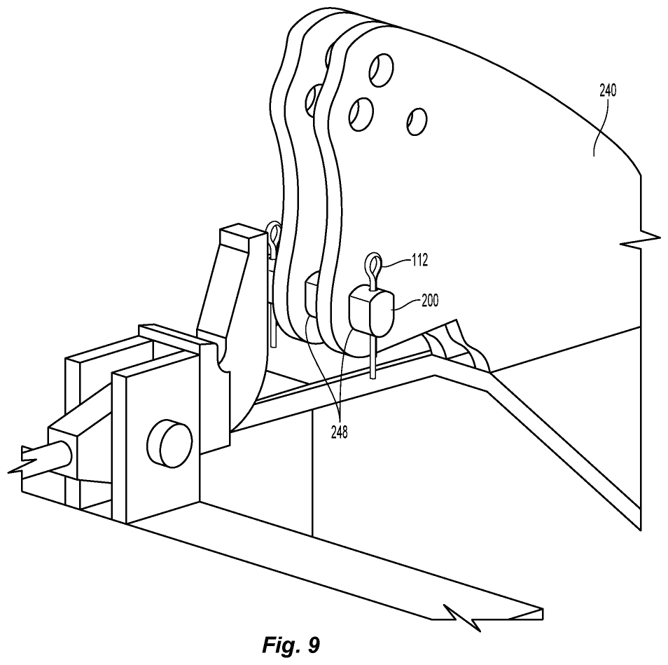

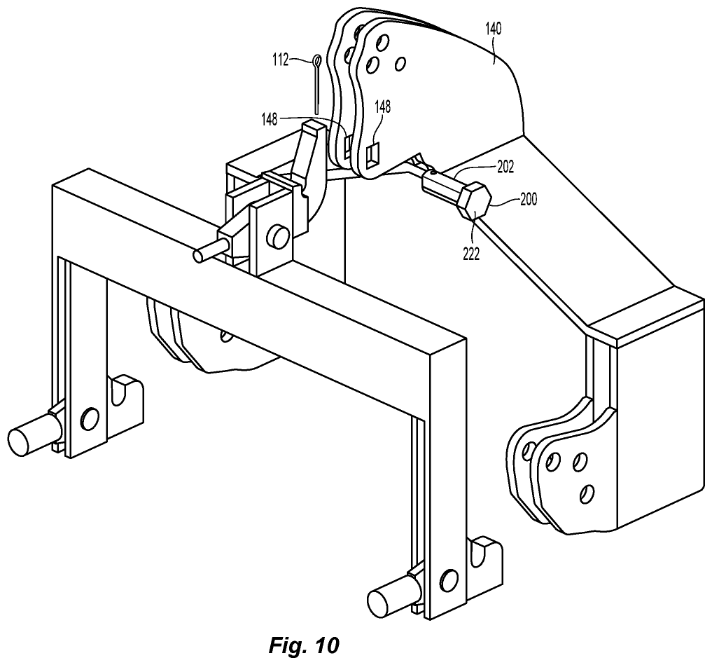

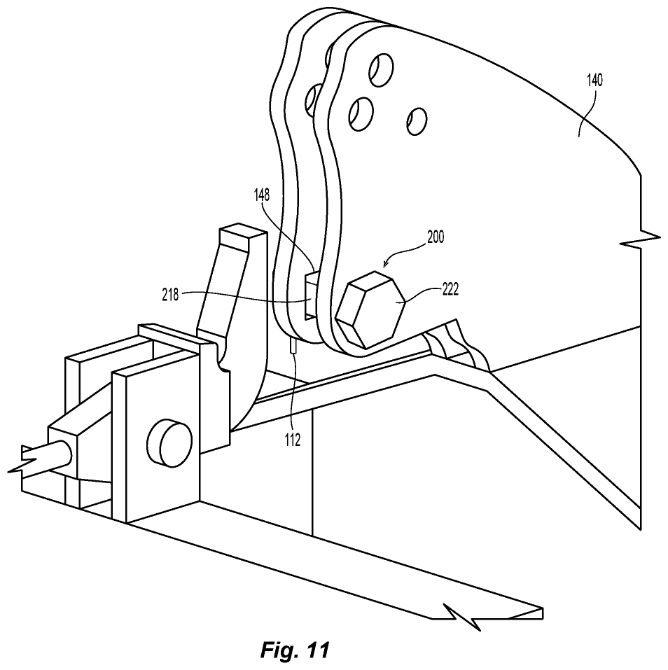

Alternative configurations of the attachment member are also presented. In FIG. 2, an alternative configuration of an attachment member 200 is illustrated. The attachment member 200, as with attachment member 100, includes an elongated member 202 having a length and extending between a first end 204 and a second end 206. The elongated member 202 has a enlarged portion or head 222 at the first end and an opening 210 adjacent the second end 206 to accept a securing member 112 as illustrated in FIG. 9. The elongated member 202 also has four sides 214,216, 218, and 220, as best seen in FIG. 2. The enlarged portion 220 eliminates the need to have two securing members 112 to retain the attachment member 200 in the support 146. As illustrated in FIGS. 10 and 11, the attachment member 200 can be inserted into the opening 148 and secured therein using the securing member 112.

Instead of the attachment member having a six-sided head 222 as illustrated in FIG. 2, an attachment member 300 according to the present invention may have a circular head 322 as illustrated in FIG. 3. Alternatively, the enlarged portion 322 could be of any shape and sized that prevents the attachment member from being pushed or pulled through the opening 148.

The openings 148 may also have alternative configurations to receive the attachment members. As illustrated, and discussed above, the openings 148 are generally rectangular and are slightly larger than the attachment members 100,200,300. However, the openings may also have a configuration that corresponds to the configuration of the attachment members 100,200,300. FIG. 9 shows openings 248 in the support 240. The openings 248 have the same configuration as attachment member 100,200,300, which is illustrated in FIG. 4. In this way, the orientation of the attachment members 100,200,300 in the support 240 is dictated by the support 240 rather than than how the user would like to insert the attachment member. As noted above, the first surface 114 has a larger radius than fourth surface 120, allowing the attachment member 100 to be inserted only one way in openings 248.

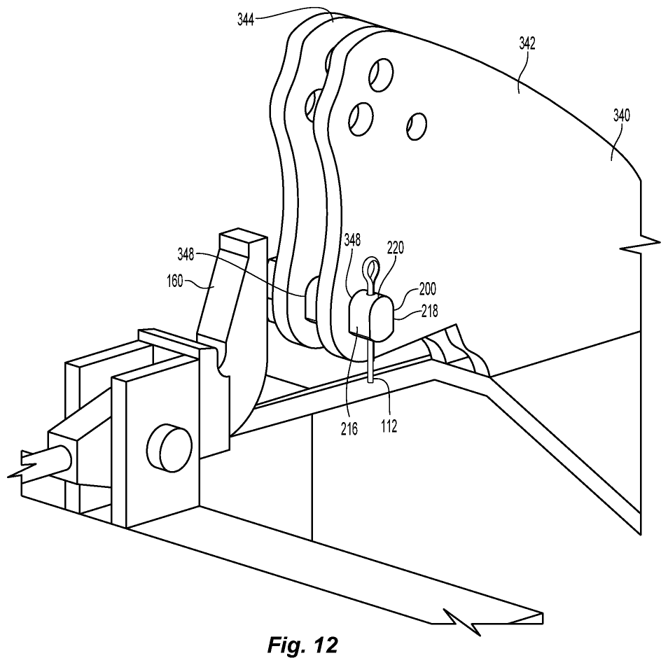

For example, another configuration of an opening is illustrated in FIG. 12. In FIG. 12, the attachment member 200 is illustrated in a portion of support 340. Each of the flanges 342, 344 have an opening 348 that is inverted relative to the opening in FIG. 9. The openings 348 are configured to match the configuration of the attachment member 100 rather than being simply rectangular openings. However, it can be seen the surface 214 is toward the bottom of the figure, while surface 220 is on the top. Cf FIG. 1. As a result, surface 216 is facing the farm vehicle. The securing member 112 can be inserted from either direction. The enlarged portion or head 222 is on the back side of the support 340 and is difficult to see in this view.

Additionally, the present invention also contemplates other configurations of the attachment member (and then also corresponding openings in the support). FIG. 5 illustrates an embodiment of attachment member 400. The attachment member 400 includes an elongated member 402 that has four surfaces or sides 414,416,418, and 420. The attachment member 400, along with those described below, would also have the features noted above associated with attachment member 100, 200, 300 if so desired. The four surfaces or sides 414,416,418, and 420 preferably extend between the first end and the second end thereof, but may also only extend along a portion of the longitudinal length of the elongated member 402 and not extend along the entire length thereof. First surface 414 is a flat surface (technically having an infinite radius). On either side of first surface 414 are generally flat surfaces 416,418. The fourth surface 420 is also preferably curved and the curved surface has a radius of 16 mm, but could be of any appropriate curvature. The radius of 16 mm matches the size of a hook opening of a category II quick hitch adapter.

As another example, an alternative configuration of the attachment member 500 is illustrated in FIG. 6. The attachment member 500 includes an elongated member 502 that has four surfaces or sides 514,516,518, and 520. The attachment member 500 would also have the features noted above associated with attachment member 100, 200, 300 if so desired. The four surfaces or sides 514,516,518, and 520 preferably extend between the first end and the second end thereof, but may also only extend along a portion of the longitudinal length of the elongated member 502 and not extend along the entire length thereof. First surface 514 is a curved surface with the radius of 22.5 mm. On either side of first surface 514 are generally flat surfaces 516,518. Finally, the fourth surface 520 has a generally flat portion 520a that interrupts the curved surface 520. Thus, the two portions 520 on either side of the generally flat portion 520a have a radius of 16 mm, but could be of any appropriate curvature.

Another configuration is of an attachment member 600 is illustrated in FIG. 7. In this embodiment of an attachment member 600, the two side surfaces 616 and 618 are slightly curved and not generally flat. Such a configuration provides for a larger cross section while still allowing for substantial contact with the hook on the support. The two side surfaces 616 and 618 have a large radius that is smaller than infinity but larger than the radius of the other surfaces of the attachment member 100.

Applicant notes that the supports may be used or as a part of farm implements such as a mower, a tiller, a rake, a scraper, a disc, a box scraper, a grader blade, a ripper tooth, a drag grapple, a pallet fork, a cultivator, a plow, and a hay spear. The farm vehicle may also be any appropriate vehicle or machine that has a three point quick hitch adapter that engages the attachment members when connected to the support elements of the farm implements.

It will be apparent to those skilled in the art that various modifications and variations can be made to the present invention without departing from the spirit and variations of this invention provided they come within the scope of the appended claims and their equivalents.

We claim:

1. A farm implement to be engaged by a quick hitch adapting unit on an agricultural machine comprising;
a first support spaced laterally from a second support;
a third support disposed between and above the first support and second support, the first support having two flanges space apart from another, the two flanges defining a space therebetween, the space between the two flanges accessible from three sides;
at least one opening in each of the two flanges of the third support; and
an attachment member disposed within the at least one opening in each of two flanges, the attachment member comprising:
a first surface extending longitudinally along at least a substantial portion of the elongated member between the first and second ends and being generally flat, the first surface configured to engage a surface of the quick hitch adapting unit;
a second surface extending longitudinally along a substantial portion of the elongated member between the first and second ends, the second surface being generally flat and being parallel to the first surface;
a third surface extending longitudinally along a substantial portion of the length of the elongated member between the first and second ends, the third surface disposed between the first and second surfaces and having a curved surface; and
a fourth surface extending longitudinally along a substantial portion of the length of the elongated member between the first and second ends, the third surface disposed between the first and second surfaces and opposite the third surface and having a curved surface, the third surface having a curvature that is different than the fourth surface.

2. The farm implement according to claim 1, wherein attachment member has a height and a width, the width extending between the first and second surfaces, the height being larger than the width.

3. The farm implement according to claim 1, wherein the agricultural machine is a farm vehicle.

4. The farm implement according to claim 1, wherein attachment member has an opening at opposite ends to receive a securing member therein.

5. The farm implement according to claim 1, wherein the attachment member has an enlarged portion to prevent the attachment member from being pulled through the flanges.

6. The farm implement according to claim 1, wherein the at least one opening in each flange is configured the same as a cross-section of the attachment number.

7. The farm implement according to claim 1, wherein the curved third surface has a first radius and the curved fourth surface has a second radius, the first radius and the second radius being the same.

8. The farm implement according to claim 1, wherein the first radius and the second radius are less than infinity.

9. The farm implement according to claim 1, wherein the curved third surface has a first radius and the curved fourth surface has a second radius, the first radius being greater than the second radius and both the first radius and the second radius are less than infinity.
